(19) United States
(12) Patent Application Publication
(10) Pub. No.: US 2015/0365420 A1
(43) Pub. Date: Dec. 17, 2015

(54) A SECURE USER INTERACTION METHOD PERFORMING DEFINED ACTIONS ON WEB RESOURCES OVER A SEPARATE CHANNEL AND A SYSTEM THEREOF

(71) Applicant: KOCHHAR, Haryana, Gurganon (IN)

(72) Inventor: Anant KOCHHAR, Haryana, IN (US)

(21) Appl. No.: 14/766,701

(22) PCT Filed: Feb. 7, 2014
(86) PCT No.: PCT/IB2014/058855

§ 371 Date: Aug. 7, 2015

(30) Foreign Application Priority Data
Feb. 8, 2013 (IN) 375/DEL/2013

(51) Int. Cl. H04L 29/06; H04L 29/08

(52) U.S. Cl. CPC H04L 63/102; H04L 67/141

(57) ABSTRACT

A method and system to facilitate a secure user interaction with a web resource on a primary device by establishing a connection on a communication channel between the primary device and the web resource. The user interacts with a secondary device utilizing a separate communication channel to perform the action.

### FIELD OF INVENTION

The present invention, in general, relates to providing interactions with web resources. More particularly, the present invention disclosed herein relates to providing a secure user interaction method and system for allowing users to interact and perform defined actions on web resources over an out-of-band communication channel.

### BACKGROUND OF THE INVENTION

A user uses a computing device to access web resources, which allow the user to perform a variety of defined actions and/or tasks. Web resources comprise websites, web portals, WAP portals, and for the purpose of this invention, the terms “web resource” and “website” will be used interchangeably. For the purpose of this invention, the computing device used for accessing web resources over an established communication channel will be referred to as the “primary device” or the “client device”.

In some circumstances, for example, when the user wishes to perform actions securely on the web resource, it may be undesirable and/or insecure for the user to perform such actions by using standard input devices, for example, the keyboard, touchpad or mouse, etc., as these are attached to the computing device on which the web resource is being accessed.

Presently in order to perform such actions, the user is required to use out-of-band communication channels using a separate device such as a mobile phone of the user. As used herein, the term “out-of-band communication channel” refers to a communication channel that is set up outside of a previously established communication channel between the primary device and the web resource. For the purpose of this invention, the terms “out-of-band communication” and “out-of-band communication network” may also be used to refer to “out-of-band communication channel”. For the purpose of this invention, such a device which communicates on an out-of-band communication channel is referred to as the “secondary device” or the “personalized device”.

Sometimes the client device and the personalized device are the same. For example when a mobile phone, able to communicate on an out-of-band communication channel, is being used for accessing the web resource, it is both a primary device and the secondary device.

Presently, a user's phone number can be implicitly discovered by a web resource when the user is using the internet connection provided by his mobile network service provider. However, it is not possible to discover the phone number of a user when he is using the internet connection of another internet service provider, for example over a Wi-fi network. In such a scenario, it is necessary for users to communicate with the web resources over an out-of-band communication channel for identification of the phone number of the user.

Conventional methods of performing such out-of-band communications with a web resource often involves performing two or more steps, comprising to and fro communications between the website loaded on the client device and the user's personalized device e.g. a mobile phone of said user. In one typical known approach, a user of website is asked to enter his/her phone number on the website. A one-time password is then generated by the backend system and transmitted to the user's personalized device linked with entered phone number via an SMS and the user is prompted to enter this one-time-password into in the webpage. When the user enters the one-time-password into the website, the action is performed by triggering an event, thereby connecting and/or synchronizing the two networks—the telephone network over which the SMS was sent to the user's personalized device and the internet protocol (IP) network over which the website is being accessed by the user's client device. This is also referred to as the ‘one-time-password’ method. This method requires several steps from the user which makes it long, cumbersome, network and system resource consuming method. As the one-time-password is generated by the backend system, it can be compromised at any one of the places where it is generated, stored or transmitted before it reaches the user's secondary device. The one-time-password method is also prone to ‘repudiation attack’ by users who can claim that they did not initiate or complete the process of out-of-band action even if they did.

User originated SMS (Short Message Service), also referred to as Mobile Originating (MO) SMS, is considered to be more secure and reliable method of ascertaining user's intent than Mobile Terminating (MT) SMS which happens when the user receives an SMS on his phone, as in the case of one-time-password method. In view of guidelines issued by TRAI (Telecom Regulatory Authority Of India), dated 4 Jun. 2011, all mobile transactions need to be validated by a user originated consent which may be in the form of user originated SMS. http://trai.gov.in/WriteReadData/Direction/Document/direction_VAS_fina4-7-2011.pdf

In several scenarios, a web resource may require a user to sign up for a web service, which typically involves asking the user to identify himself by entering personal details and setting up a user credential like a username and a password. This process is long, cumbersome, and uses precious network and system resources. It is also insecure as user entered values cannot be authenticated separately. Further, a security vulnerability in the user's primary device may lead to compromise of user's credentials.

Further, under certain circumstances, it is also necessary to ascertain the mobile network service provider along with the user's phone number. For those phones which have availed ‘Mobile Number Portability’ service and migrated from their original mobile network service provider to another mobile network service provider, their phone number patterns no longer map to corresponding mobile network service providers. Hence, the above described method of ‘one-time-password’ is not able to successfully map the phone number to a mobile operator.

In the current invention, when each mobile network service provider sets up a separate gateway for incoming out-of-band action from mobile phone users, it becomes possible to detect the mobile network service provider of even those users who have migrated from one mobile network service provider to another using MNP service.

A long felt need therefore exists for a method and system that enables execution of actions securely on a website using an out-of-band communication channel while still providing a seamless one step secure process, allowing for mobile number discovery even on non-network operator internet, allowing for positive identification of user's mobile network service provider even if the user has used Mobile Number Portability to move from one mobile network services provider to another, thereby overcoming above mentioned drawbacks of the systems discussed above and also several other shortcomings inherent to the existing technologies including but not limited to ‘one-time-password’ method. A need also exists for a seamless system that enables users to sign-in into a website without users using their primary device, while still successfully identifying themselves.

### SUMMARY

The above-mentioned shortcomings, disadvantages and problems are addressed herein which will be understood by reading and understanding the following specification.

In an embodiment the present invention provides a method and system to facilitate a secure user interaction with a web resource on a primary device comprising by-establishing a connection on a communication channel between the primary device and the web resource,-interacting with a secondary device by a user and -utilizing a second communication channel referred to as out-of-band communication.

In another embodiment the present invention provides a secure method and system of performing actions on a web resources using out-of-band communication comprising: by-requesting, via a primary device operable by a user, a web resource with defined actions being hosted at a web server, establishing a connection between the primary device and the web server in response to said request, generate and associate unique out-of-band actions to the said defined actions on the web resource by an access control module associated with the web resource, receiving the web resource on the primary device, periodically polling the access control module by the primary device on the status of the completion of the out-of-band action, performing an out-of-band action using a secondary device over an out-of-band communication channel connected to a gateway, receiving the out-of-band action by the access control module from the gateway and matching it with the associated action on the web resource, periodically polling the access control module by the primary device for the status of the completion of the out-of-band action and receiving a confirmation for the completion of the said out-of-band action, triggering an event at the primary device in case result of polling for an out-of-band action indicates successful matching.

In another embodiment the present invention a unique out of band action is conveyed to the user by a unique visual cue.

In another embodiment the present invention actions on the web resource are assigned unique identifiers.

In another embodiment the present invention web resources are loaded on the primary device on a specialized application such as a web browser and an action on the web resource is uniquely identified by a unique browser session identification value stored as a browser cookie value.

In another embodiment the present invention a series of out-of-band actions need to be performed for triggering an event on the primary device.

In another embodiment the present invention a series of out-of-band actions need to be performed for triggering an event on the primary device.

In another embodiment the present invention polling is initiated by the user of the primary device.

In another embodiment the present invention the web resource comprises a website or a web portal.

In an embodiment the present invention secondary device is selectively coupled with the primary device via out of band communication network, gateway, and an access control module.

In an embodiment of the present invention In comprising detection of the phone number of the user's secondary device on the web resource.

In another embodiment of the present invention wherein steps performed by the said primary device are additionally and in parallel performed by the secondary device over discreet channels.

In yet another embodiment of the present invention provides a system comprising: a primary device operable by a user to request a web resource with defined actions, receive the web resource, periodically poll the access control module on the status of the completion of the out-of-band action, receive a confirmation for the completion of the said out-of-band action and trigger an event in case result of polling for an out-of-band action indicates successful matching, a web server to host said defined actions and establish a connection between the primary device and the web server in response to said request, an access control module associated with the web resource to generate and associate unique out-of-band actions to the said defined actions on the web resource, receive the out-of-band action from a gateway and matching it with the associated action on the web resource and, a secondary device to perform an out-of-band action over an out-of-band communication channel connected to the gateway.

A system and method for enabling a user to perform one or more actions on a web resource on a primary device by using one or more out-of-band actions performed by a secondary device is provided.

A primary device refers to an electronic device capable of loading a web resource hosted on a web server. The term “web browser” refers to any program on a primary device which can render a web resource over a network on the said primary device. Common examples of web browsers include Internet Explorer, Mozilla Firefox, Safari Browser, Opera, Google Chrome browser, and other applications with in-built web resource rendering engines like mobile applications. These web browsers allow automatic triggering of events on web resources by use of technologies like Javascript. Such events comprise polling periodically, requesting another web resource or changing the state of the web resource loaded on the web browser. The web resources allow users to perform actions which comprise logging in, navigation to another web resource, enabling disabled features, giving consent for another action, and making or authorizing secure transactions.

A secondary device refers to any device which can communicate over an out-of-band communication channel with a gateway and is able to complete an out-of-band action. A secondary device can be a SIM-enabled device like a mobile phone capable of sending SMS, making a call, initiating USSD session.

As used herein, the term “out-of-band communication channel” refers to a communication channel that is set up outside of a previously established communication channel between the primary device and the web resource. As used herein, the term “out-of-band action” refer to an action performed over an out-of-band communication channel established between the secondary device and a gateway. When the secondary device is a mobile phone device, the out-of-band actions comprise of sending a SMS to a specified phone number, making a phone call to a specified number and/or interacting with an IVR system, initiating a USSD session with a specified USSD code. For the purpose of describing the present invention, out-of-band communication channel and out-of-band communication network refers to the same thing.

A gateway is a hardware device which can receive communications over an out-of-band communication channel from the secondary device and relay these communications to an access control module. For example, when the out-of-band action is sending an SMS from a mobile phone device, the gateway is a device capable of receiving the SMS, commonly referred to as an SMS Center.

The ‘access control module’ drives the process for setting up the ‘out-of-band’ action, maps out-of-band actions to actions on web resources, receives relayed communication from the gateway for actions completed on the out-of-band communication channel, as well as confirms the completion of the out-of-band actions to the primary device.

The system comprises a web server capable of hosting a web resource, a primary device capable of accessing web resource from the web server, a secondary device capable of performing an ‘out-of-band action’, a gateway device capable of receiving communication from the secondary device over the out-of-band communication channel, and an ‘access control module’ which generates and matches out-of-band actions to actions on the web resource as well as receive communications from the gateway device.

The access control module generates a unique out-of-band action and maps it to each action on the web resource. This mapping comprises generating and using a unique identifier which uniquely identifies each action on a web resource as well as the out-of-band action on the access control module. This unique identifier is made available to the web resource and is used by the web resource to query the access control module.

The out-of-band action is conveyed to the user of the primary device using a visual cue. The visual cue comprises, for example, a unique code comprising human readable strings of letters, alphabets, and special characters, or a unique machine readable code such as a QR code, a barcode, etc., which decodes into the unique code or data blocks. A person ordinary skilled in the art will appreciate that in the case of human readable string of letters, a dictionary word or a phonetic word can be used to help a user remember the cue. The visual cue in an embodiment may be in the form of a “button” on WAP sites and mobile apps, which when pressed invokes the corresponding SMS sending application of the mobile device. This event may additionally prefill the recipient field and the body field of the SMS automatically and/or automatically send the SMS.

Before displaying the visual cue, the strength of the established connection between the web server and the primary device of the user can be ascertained. In the case when poor connectivity is detected, the visual cue is not displayed and the process is automatically cancelled.

The user may be given a pre-determined time interval to complete the out-of-band action. The pre-determined time interval may be displayed to the user in form of a timer next to the visual cue. For example, sending an SMS code to a specified number will perform a login action on a web resource, only if the user sends the SMS within 5 minutes from it being displayed to the user.

After displaying the visual cue on the website, the web browser on the client device polls the access control module in a timed loop for confirming completion of the out-of-band action as described with respect to the visual cue. As used herein, polling means performing a periodic check. Web browsers can automatically poll the access control module using a number of web browser technologies like those referred to as Web 2.0 technologies, AJAX, browser plug-in technologies, Java applet, ActiveX controls, Silverlight.

The polling is done by sending the unique identifier in a request to the access control module. The unique identifier is a unique data set generated by the access control module for mapping actions on the web resource to the out-of-band action.

As soon as the gateway receives an out-of-band action on the out-of-band communication channel, it relays that information to the access control module. In one embodiment, the gateway communicates with the access control module over an appropriate network.

As soon as the access control module receives information on an out-of-band action from the gateway, it maps the out-of-band action to a unique identifier and is ready to confirm the completion of the out of band action in the response to a polling request carrying the unique identifier which is mapped to the out-of-band action from the client device. This process is also referred to as “matching”.

When the access control module confirms the completion of the out-of-band action to the client device in response to a polling request, an event is triggered on the browser using scripts or programs written in web browser technologies like Javascript. This event causes a state change on the web resource and the user performs an action on the web resource without using traditional input methods

In an embodiment of this invention, the polling is done manually by the user, for example by pressing a button which triggers a request to the access control module for checking the status of the out-of-band action. This implementation is required for browsers which lack web browser script support, those which use a proxy mechanism in the backend of fast loading of web resource, or in scenarios where the established connection between the client device and the web server becomes poor during the course of time.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 exemplarily illustrates an exemplary system architecture for enabling a user to perform one or more browser actions on a website hosted on a web server and accessed over an established network by a client device, using an out-of-band communication channel available to a secondary device.

FIG. 2 exemplarily gives an example of a personal computer (PC) device as the primary device, keyboard and mouse attached to the PC as the primary input devices, and a mobile phone device as the secondary device.

FIG. 3 exemplarily illustrates a method for performing an SMS based out-of-band communication, for enabling execution of an action on the web resource.

FIG. 4 exemplarily illustrates a system of user interaction on the web resource on a personal computing device, which is the primary device, by performing out-of-band action of sending an SMS using the mobile phone, which is the secondary device.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The present invention relates to a system 100 and method for performing actions on a web resource 102 hosted at a web server 101 from where it can retrieved and loaded on a client device 104 via web browser 105 by performing out-of-band actions using a personalized device 107.

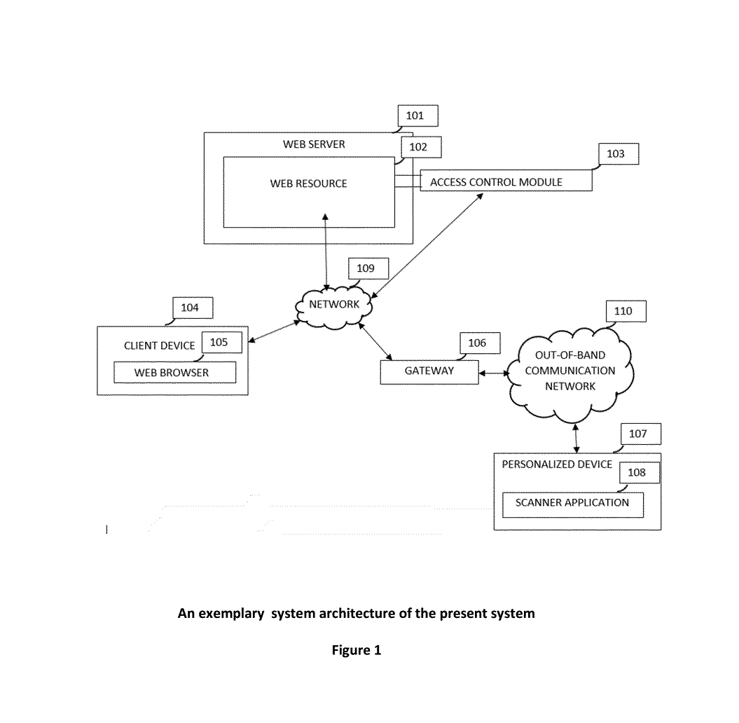

FIG. 1 exemplarily illustrates a system architecture 100 in one embodiment of the invention, for performing one or more actions on the web resource 102 using the out-of-band communication network 110. As used herein, the term “actions on a web resource” comprise, of logging into a web resource, navigating to another web resource, enabling buttons, enabling data submission forms, enabling disabled features, giving consent for another action, and making or authorizing secure transactions between multiple systems.

A web server within the purview of the invention may refer to either the hardware (the computer) or the software (the computer application) or in any combination thereof, that helps to deliver web resource that can be accessed through the Internet. As a person having ordinary skilled in the art may note that the most common use of web servers is to host websites, but it may include data storage or running enterprise applications etc. Typically, the primary function of a web server is to cater web page to the request of clients using e.g. Hypertext Transfer Protocol (HTTP).

As used herein, the “client device” 104 refers to an electronic device, for example, a personal computer, a mobile computing device, a personal digital assistant, a tablet computer, or any other communication device capable of connecting to the web resource 102 via a network 109. The terms client device and primary device will be used interchangeably. The web browser 105 refers to a software application for retrieving, presenting, and accessing the web resource 102 residing at a web server 101. A request for accessing the web resource 102 in a typical known scenario may be sent from the client device 104 by typing the uniform resource locator (URL) of the desired web resource 102 on the web browser 105 on the client device 104. As used herein, the phrases ‘browser action’ and ‘action on a web resource’ may be used interchangeably.

A person ordinarily skilled in the art would appreciate that a web resource, like a website, is considered ‘hosted’ on a web server when a set of computer codes stored on the web server, for example inside computer files, is processed by the web server's processing engine on receiving a request for that web resource over a network from a computer application, like a web browser running on a client device, like a personal computer. For example, when a user enters the URL (universal resource locator) of a website in a web browser, a request is sent to the web server from the client device for the web resource referenced by the URL. The web server's processing engine processes these computer codes into an output code which is in a format which can be processed by the computer application requesting the web resource. For example HTML (HyperText Markup Language) and Javascript is a format which can be processed by a browser. The web server then transmits the processed output code over a network as response to the original request from the client device and in turn to the web browser. On receiving the response over the network, the web browser processes the code. At this stage, the web resource is ‘loaded’ in the computer application. Thus, when a web browser receives the output containing HTML code from a web server as a response to a request for a web site, and upon receiving the HTML code from the web server, processes the HTML code and renders it for visual representation on the screen of a personal computer, it is considered that the web site is ‘loaded’ on the web browser and that the web resource is loaded on the client device. Further, a person ordinarily skilled in the art would appreciate that the protocol used for transmission of data between client devices and web servers is HTTP (Hyper Text Transfer Protocol). As HTTP is stateless, that is each request is independent of any previous request, the state is maintained by the website by using unique session identifiers typically stored in browser cookies, which is transmitted with every request. Using these cookies, a web resource is able to tell whether a user is logged in or not as the session is activated when a user is logged in.

A network 109 is, for example, a local area network, a wide area network, a wireless network, a telecommunication network, etc. The telecommunication network is, for example, a global system for mobile communications (GSM) network, a general packet radio service (GPRS) network, a code division multiple access (CDMA) system, enhanced data GSM environment (EDGE), wideband CDMA (WCDMA), etc.

The system architecture 100 disclosed herein comprises a web server 101 configurable for hosting a website 102, a client device 104 capable of loading and executing a web browser (105) capable of loading web resources, a gateway 106, and a personalized device 107. For the purpose of describing this system, the terms personalized device and secondary device will be used interchangeably. The system further comprises an access control module 103 associated and/or integrated with the web resource 102 either directly or indirectly. The website 102 communicates with a web browser 105 on the client device 104 over the network 109. The web browser 105 running on a client device 104 communicates with the web resource 102 loaded on the web server 101 over the network 109. The secondary device 107 can be a cell phone, a smart phone, a personal digital assistant (PDA), a wireless email terminal, a laptop, a tablet computer, etc. The secondary device 107 uses the out-of-band communication network 110 to connect with the gateway 107 which in turn connects to the access control module 103.

A gateway is a device that acts as a connector between computing devices/network nodes operating in a network. A Gateway may further contain devices such as protocol translators, impedance matching devices, rate converters, fault isolators, or signal translators as necessary to provide system interoperability. In the present case, the gateway 106 receives communication over out-of-band communication channel 110 from the secondary device 107 as well as communicates with the access control module 103.

As indicated out-of-band refers to communications which occur outside of a previously established communication method or channel in order to achieve some advantage. In computer networking, out-of-band data refers to a separate stream of data from the main data stream. Further, in authentication, out-of-band refers to utilizing two separate networks or channels, one of which being different from the primary network or channel, simultaneously used to communicate between two parties or devices for identifying a user.

The gateway 106 is, for example, a Short Message Service (SMS) gateway or a web gateway. The SMS gateway refers to a telecommunications network facility for sending or receiving messages to or from a network that supports SMS. The term “web gateway” refers to online network node that serves as an entrance to another network node such as the access control module 103. In an embodiment, the gateway 106 is integrated with the access control module 103. In another embodiment, the gateway 106 may be separate from the access control module 103.

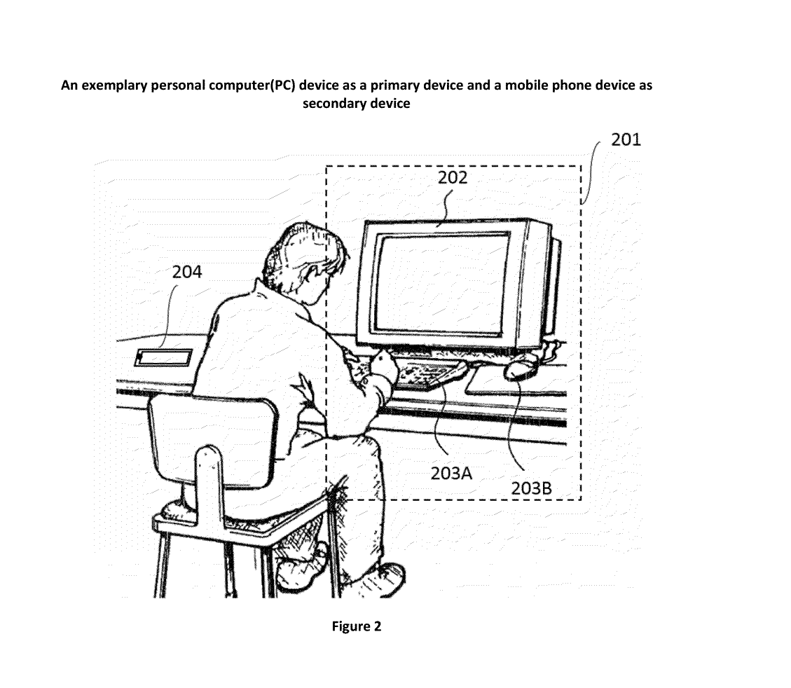

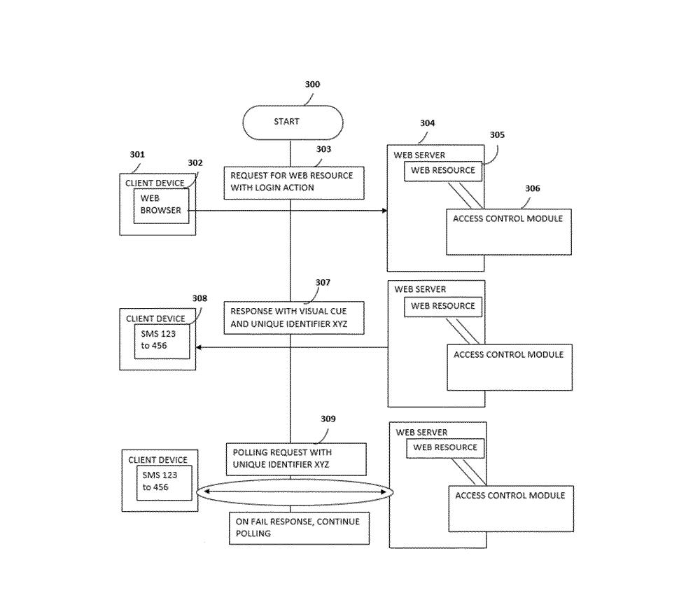

FIG. 2 illustrates an exemplary setup of a personal computer (PC) 201 as the primary device 104 in FIG. 1, and a mobile phone device 204 as the secondary device 107. The primary input devices are keyboard 203A and mouse 203B attached to the primary device 201.

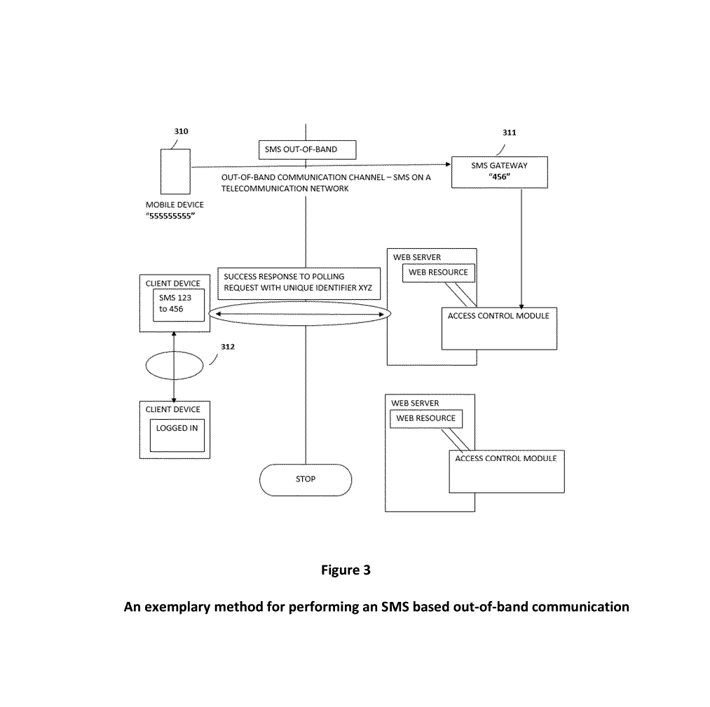

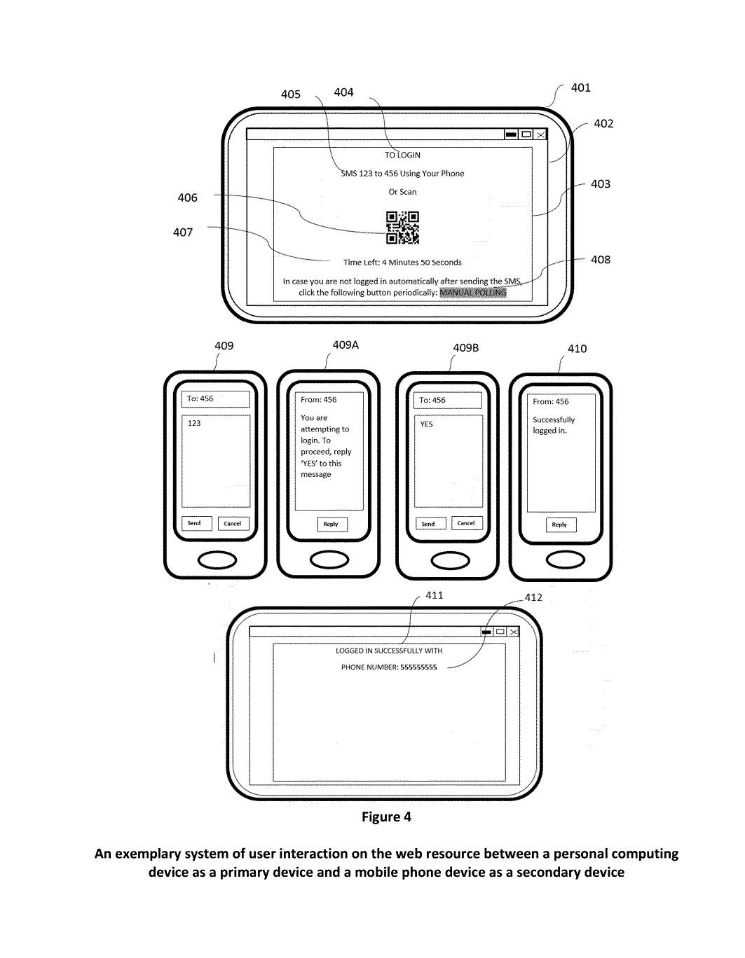

FIG. 3 and FIG. 4 together illustrates an example of performing an action on a web resource 305 on the client device 301 over an out-of-band communication channel using the secondary device which is a mobile phone device 310, where the out-of-band communication channel is the telecommunication network over which an SMS can be transmitted and received. The action on the web resource in this example is to login into the web resource and the out-of-band action in this example comprise sending an SMS containing a unique code to a specified phone number.

The gateway 311 in FIG. 3 is a device capable of receiving SMS from the secondary device 310 and communicating with the access control module 306, The gateway 311 may also referred to as an SMS gateway. The SMS gateway 311 refers to a telecommunications network facility for sending or receiving text messages to or from a network that supports SMS. The SMS gateway in line with the objectives of the present invention has an identification number in the form of a specified phone number attached to it to which users can send the SMS to using their mobile devices. In one embodiment, the number assigned is a short code which is a special non-regular phone number of lesser length than a regular phone number. This short code is assigned to an SMS gateway individually at each mobile network service provider's end, so that when a user sends the SMS to this number, that SMS will terminate at the short code SMS gateway of that mobile network service provider whose services the user is using on his mobile phone. This termination of the SMS at the ‘home’ mobile network service provider enables discovery of the mobile network service provider of the user's mobile phone.

In another embodiment, the out-of-band action comprises making a phone call from the secondary device, wherein the user dials a number and follows instruction on the call. In this embodiment, the gateway 106 is, for example, an interactive voice response (IVR) system.

A request 303 for the web resource 305 is sent from the web browser 302 operating on the client device 301 to the web server 304 hosting the web resource 305. The access control module 306 associated with the web resource 305 generates a unique out-of-band action and maps it to the action on the web resource 305. The access control module 306 maps this out-of-band action with the action on the web resource by generating a unique identifier. This unique identifier is made available to the web resource 305 by the access control module 306 and is transmitted to the client device as shown in 307. In the example illustrated in FIG. 3A, the unique identifier is XYZ. This unique identifier is used by the web resource loaded on the web browser to query the access control module for checking the status of the mapped out-of-band action.

In one embodiment of this invention the unique identifier is made available on the web resource by the access control module and is used by the web resource to query the access control module in the form of the unique session identifier of the web browser stored as a name value pair in the cookie of the said browser. In another embodiment, the unique identifier is made available on the web resource by the access control module and is used by the web resource to query the access control module in the form of a HTTP Request header name value pair. In another embodiment, the unique identifier is made available on the web resource by the access control module and is used by the web resource to query the access control module in the form of a URL name value parameter. In another embodiment, the unique identifier is made available on the web resource by the access control module and is used by the web resource to query the access control module in the form of a Form or POST body name-value pair parameter.

Information conveying the out-of-band action is communicated using a visual cue 308 on the web resource loaded in the web browser 302.

In one embodiment of the invention, a pre-determined time interval will be associated with the unique out-of-band action within which it must be completed for the action on the web resource to execute. For example, users will be given 5 minutes to the specified SMS for the login action to occur on the web resource.

In one embodiment of the invention, the access control module 306 does not assign the same unique out-of-band action to any other simultaneously occurring interaction on another client device.

As illustrated in FIG. 4, the web resource is loaded on the primary device 401 in the web browser 402 and communicates the out-of-band action by means of a visual cue 403. The visual cue comprises of the action on the web resource 404 which is ‘TO LOGIN’, the unique out-of-band action 405 which is to send the unique code ‘123’ as an SMS to the specified phone number ‘456’, the machine readable form of the out-of-band action in the form of a QR code 406, information regarding the pre-determined time interval for the out-of-band action to be completed 407, and a facility for the user to poll manually with the access control module by pressing on a button 408.

When the machine readable code is in the form of a QR code, the QR code comprises the unique code and the phone number to which the said unique code has to be sent via SMS. The QR code refers to a type of two-dimensional barcode used to represent numbers or other data. The user may scan the QR code using the scanner application 108 installed on the secondary device 107. The scanner application 108 scans the displayed QR code and decodes the QR code to extract the encoded information. The scanner application 108 then transmits the unique code to the access control module 102 over the out-of-band communication network 110, either automatically or by requiring further action from the user.

In another embodiment of the invention, information conveyed by the visual cue may be conveyed using a non-visual method, like an audio cue where the user has to listen for the instructions to perform the out-of-band action.

After displaying the visual cue, the web resource on the web browser 402 polls the access control module 306 for confirming completion of the out-of-band action by sending a query request containing the unique identifier of the out-of-band action as mentioned in [0051] and [0052]. The “polling” within the context of the invention refers to the web browser sending a request, over HTTP/HTTPS or any other browser supported network protocol to the access control module over the network. Polling is performed using scripts which are part of the web resource and written in web browser technologies like Javascript, AJAX, JAVA applets.

In response to the polling request, the access control module replies with a failure or a success response depending on whether it can confirm the completion of the out-of-band action. In case of failed response, the polling continues.

In an embodiment of this invention, the polling is done manually by the user, for example by pressing the button 408 which triggers a request to the access control module for checking the status of the out-of-band action. This implementation is required for browsers which lack web browser script support, those which use a proxy mechanism in the backend of fast loading of web resource, or in scenarios where the established connection between the client device and the web server becomes poor during the course of time.

The out-of-band action is performed as illustrated in 409 by sending ‘123’ in an SM to ‘456’ using the mobile device 310 with the assigned phone number as ‘5555555555’. In the current example, ‘456’ is the phone number attached to the SMS gateway 311. In this way, the mobile device 310 communicates to the SMS gateway 311 via SMS. In an embodiment, the gateway is able to initiate communication to the secondary device over the out-of-band communication channel. In an embodiment, the user is prompted to perform a series of out-of-band actions for executing a particular browser action. In an embodiment the user may receive a return SMS from the SMS gateway prompting the user to send back another SMS with a consent in the form of ‘YES’ to the SMS gateway as shown in 410A and 410B.

When the SMS gateway 311 receives the SMS containing the string ‘123’, which is the out-of-band action in this case, on the telecommunication network, which is the out-of-band communication channel in this example, from the mobile phone 310, it relays that information to the access control module 306. In an embodiment, the SMS gateway 311 parses the SMS received from the secondary device 310 and sends the content of the SMS, that is, the unique code ‘123’ and the phone number ‘555555555’ of the secondary device 310 to the access control module 306.

As soon as the access control module 306 receives information on the received SMS from the gateway 311, it matches SMS content to a unique identifier ‘XYZ’. The access control module is now ready to confirm the completion of the out-of-band action in the response to a polling request carrying the unique identifier ‘XYZ’ from the web browser 302 on the client device 301.

In response to the polling request 309 carrying the unique identifier, the access control module 306 replies with a success response. In an embodiment, the success response may also contain the phone number of the secondary device 310 as received from the gateway 311. In an embodiment, the access control module 306 may communicate with web resource 305 to perform further actions, like activation of session objects mapped by the browser cookies for purpose of logging in the user into the web resource 305.

The success response to the polling triggers an event on the client device 312. In FIG. 4, the triggered event on the web resource 403 loaded on the web browser 402 ensures that the action of login on the web resource is performed as shown in 411.

In another embodiment of the invention, the out-of-band action is a web based out-of-band action. In this embodiment, the gateway 106 is a web gateway. The user may send the unique code from the visual cue to the web gateway (106) by submitting the unique code manually or using the scanner application 108 on the mobile computing device (107). The web gateway (106) can be the access control module 102 itself or a series of one or more intermediary network nodes or websites including web portals which ensure that the information is finally transmitted to the access control module 102. In another embodiment, the specified network nodes addresses can either be hard-coded in the scanner application 108 or can be part of the decoded QR code information.

Several mobile device/phone browsers on various popular phone operating system platforms, for example Android, Apple iOS, and Nokia S40 series, allow users to invoke the SMS application directly from the browser at the click of a button on customized hyperlinks using keyword tags like ‘sms’ or ‘smsto’. In an embodiment, when the primary device 104 and the secondary device 107 are the same, as in the case of a smartphone device capable of accessing a web resource as well as sending an SMS, the user is shown and prompted to click on a button on the web browser 105. When the user clicks on the button, the SMS application of the smartphone is automatically invoked and opened up with the SMS body field as well as the SMS recipient field automatically filled up.

Thus, the present invention makes it possible to login a user into a website using the above described SMS based out-of-band action. The user is either logged in with his unique mobile device/phone number or an account name associated with the user's mobile device/phone number. As shown in FIG. 4, the web resource 403 logs the user in with his mobile device/phone number as his account identifier in 412. The present invention is also used as a login system thereby reducing the signup and the login page requirement.

The underlying architecture of an exemplary mobile device OR web server and/or gateway of the present invention, collectively referred herein as hardware integers/elements is explained with reference to FIG. 5.

The CPU bus (502) is, essentially, an interconnection wires that all subsystems are connected to. In general, only one pair of devices can talk to each other at a time, so communication of the bus must be coordinated to prevent message collisions. This coordination is often handled by the CPU (501).

The central processing unit (CPU) (501) executes instructions contained in memory (503). These instructions are executed at a rate specified by the computer's clock (504).

The CPU (501) needs to access two different types of memory (503) in order to execute a program. There are two types of memories used in micro-controllers. These are read-only memory (ROM) (507) and random access memory (RAM) (508).

In a micro-controller, read-only memory (ROM) (507) is used to store permanent programs, operating drivers, and data. Many micro-controllers use erasable programmable read-only memory (EPROM) or electrically erasable programmable read-only memory (EEPROM) to store programs, operating drivers, and data. EPROM and EEPROM are non-volatile memories.

Random access memory or RAM (508) is used to temporarily store data and instructions.

The relevant components of hardware integers/elements of the present invention selectively comprise of:

Signal Control Unit (not Shown):
Device: Mainly comprising of CPU+software in memory+rf section, for controlling the bandwidth usage in device.
Service provider network: Mainly comprising of server+software in memory+rf section, for controlling the bandwidth usage in network.

Memory Unit:
Device: Mainly comprising of memory, for storing software+data associated with one or more services/tasks/operations as transceived by the said signal control unit.
Service provider network: Mainly comprising of memory, for storing software+data associated with one or more services/tasks/operations as transceived by the said signal control unit

Signal Processing Unit:
Device: Mainly comprising of CPU+software in memory+speaker, for processing short switching trigger data pulse signal to accomplish the operations by performing output to the speaker after recalling the corresponding service memory from device and confirm to network provider/operator.
Service provider network: Mainly comprising of server+software in memory, for processing short switching trigger data pulse signal to accomplish the operations by transceiving to device and confirmation from device.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-34. (canceled)

35. A secure method for performing a defined action on a web resource, comprising:
requesting, via a client device, the web resource with the defined action hosted at a web server;
establishing a connection between the client device and the web-server;
generating, via an access control module, a unique code associated with the defined action;
receiving the web resource on the client device,
wherein the web resource displays the associated unique code and a short code number, and
wherein the short code number is assigned by a mobile network service provider to a SMS-gateway;
performing an out-of-band action, wherein the out-of-band action further comprises sending a SMS with the unique code to the short code number assigned to the SMS-gateway;
forwarding the SMS having the unique code to the access control module;
determining the mobile network service provider based on receipt of the SMS at the access control module;
validating the received unique code at the access control module; and
triggering an event based on successful validation of the received unique code, leading to completion of the defined action at the client device.

36. The secure method for performing a defined action on a web resource as claimed in claim 35, wherein the out-of-band action is performed using the client device or a personalized device.

37. The secure method for performing a defined action on a web resource as claimed in claim 35, wherein the unique code displayed at the client device is a machine readable code.

38. The secure method for performing a defined action on a web resource as claimed in claim 35, may further comprise scanning the machine readable code, via the client device or the personalized device, to decode the information of said machine readable code.

39. The secure method for performing a defined action on a web resource as claimed in claim 38, may further comprise sending the decoded information to the SMS gateway.

40. The secure method for performing a defined action on a web resource as claimed in claim 35, further comprising periodically polling the access control module, via the client device, for a status of completion of the out of band action.

41. The secure method for performing a defined action on a web resource as claimed in claim 35, wherein the out-of-band action is performed in a predetermined time interval.

42. A system for performing a defined action on a web resource, comprising:
a client device connected to a web server, wherein the web server hosts a web resource with a defined action;
an access control module associated with the web resource to generate a unique code associated with the defined action;
a SMS gateway connected to the access control module, wherein the SMS gateway is assigned a short code number; and
a display unit coupled to the client device, for displaying the associated unique code and the short code number on the web resource,
wherein the client device sends a SMS with the unique code to the short code number assigned to the SMS gateway via an out-of-band communication network;
wherein said SMS gateway forwards the SMS having the unique code to the access control module,
wherein said access control module determines the mobile service provider associated with the client device based on receipt of the SMS at the access control module,
wherein the access control module validates the received unique code and triggers an event based on successful validation of the unique code leading to completion of the defined action at the client device.

43. The system for performing a defined action on a web resource as claimed in claim 42, wherein the unique code associated with the web resource is a machine readable code.

44. The system for performing a defined action on a web resource as claimed in claim 42, wherein the web resource comprises a website or a web portal.

45. A system for performing a defined action on a web resource, comprising:
a primary device connected to a web server, wherein the web server hosts a web resource with a defined action;
an access control module, associated with the web resource, to generate a unique code associated with the defined action;
a SMS gateway connected to the access control module, wherein the SMS gateway is assigned a short code number;
a display unit coupled to the primary device, for displaying the associated unique code and the short code number on the web resource; and
a secondary device connected to the SMS gateway via an out-of-band communication network,
wherein the secondary device sends a SMS with the unique code to the short code number assigned to the SMS gateway;
wherein said SMS gateway forwards the SMS having the unique code to the access control module,
wherein said access control module determines the mobile service provider associated with the secondary device based on receipt of the SMS at the access control module,
wherein the access control module validates the received unique code and triggers an event based on successful validation of the unique code leading to completion of the defined action at the primary device.
